(19) United States
(12) Patent Application Publication
(10) Pub. No.: US 2016/0372771 A1
(43) Pub. Date: Dec. 22, 2016

(54) FLOW-ABLE BATTERY WITH CHARGING AND DISCHARGING SYSTEM

(71) Applicant: Peter Mark Smith, Singapore (SG)

(72) Inventor: Peter Mark Smith, Singapore (SG)

(21) Appl. No.: 15/186,483

(22) Filed: Jun. 19, 2016

Related U.S. Application Data
(60) Provisional application No. 62/182,431, filed on Jun. 20, 2015.

(51) Int. Cl. H01M 8/04828; H01M 8/02; H01M 16/00; H01M 8/18; H01M 8/20

(52) U.S. Cl. CPC H01M 8/04895; H01M 8/188; H01M 8/20; H01M 16/003; H01M 8/02; H01M 2250/20

(57) ABSTRACT

A system for energy storage and transfer comprises a low friction non-conductive fluid, rechargeable electrical energy carriers suspended in the non-conductive fluid, and a means for transferring, via pressure, rechargeable electrical energy carriers suspended in non-conductive fluid from a storage container through an electrical energy transfer system. Each electrical energy carrier lacks sharp edges and has a diameter under ten centimeters and an external surface including an orientation feature, a positive electrode, a negative electrode, and a sealed housing between the electrodes. The electrical energy carrier suspension is transferred using non-conductive pipes between the storage container and the electrical energy transfer system, a pressure source, and an alignment mechanism that interacts with orientation features of the electrical energy carriers to align them into a single layer with matching orientation as they pass through a channel with conductive plates on opposite sides and make electrical contact with the conductive plates.

### CROSS-REFERENCE TO RELATED APPLICATION

This application claims priority to and the benefit of U.S. Provision Application No. 62/182,431 filed Jun. 20, 2015 titled “Flow-able Battery with Charging and Discharging System” which is hereby incorporated herein by reference in its entirety.

### INCORPORATION BY REFERENCE

All patents, patent applications, and publications cited herein are hereby incorporated by reference in their entirety in order to more fully describe the state of the art as known to those skilled therein at the time of the invention described herein.

### TECHNICAL FIELD

This disclosure relates generally to systems and methods for electrical storage and transfer, and more specifically to flow systems for small electrical energy carriers for providing electric power and applications thereof.

### BACKGROUND

While the pace of electric vehicle (EV) adoption and development has picked up globally, the problems of range and vehicle utility still exist for EVs due to limitations of available recharging methods. Batteries, battery cells, and capacitors all store electrical energy and are available in many shapes and forms. Some battery designs are standardized into single or multiple cell arrangements. As of yet there is no standardized design for an EV battery (which normally consists of many cells connected together in parallel and series arrangements). Although there have been attempts to standardize, they have failed due to lack of industry agreement or market support. The automobile manufacturing industry currently installs batteries of different chemistries, shapes, sizes and capacities into EVs.

Lack of battery standardization means that EV owners and operators may lack alternatives for recharging apart from connecting to an electrical outlet. However, electrical limitations to the recharge rate of these pre-installed battery packs result in long recharge periods. This significantly hinders adoption and use of EVs for long distance or ad hoc unplanned travel since the recharge period for an EV is far greater than the refueling time for a hydrocarbon fuelled internal combustion powered vehicle.

Lack of standardization for EV batteries and battery cells has caused mechanical systems for changing out battery packs to fail commercially. Better Place, Inc., a venture-backed international company that developed and sold battery-charging and battery-switching services for EVs failed in part because standard battery designs have not been adopted.

In addition to many non-standardized shapes and forms, at least 36 different battery chemistries exist or are being developed. Rechargeable batteries may be ranked in terms of energy density, as shown in FIG. 1. While the current choice of battery chemistry for electric vehicles (EVs) is Li-Ion-Polymer, this chemistry may be displaced by battery chemistry with higher energy density, such as Na-Air, Li-Air or Si-Air. Metal-air batteries, while offering the highest possible energy density, are actually the battery chemistries that currently have the least commercial development or availability. In particular, the batteries with the highest energy density, Si-Air batteries, have been publicly discussed (Gil Cohn, 2009) and described by U.S. Patent Application Nos. 2012/0299550 and 2011/0318657.

To solve the problems of range and utility, EV designers and manufacturers also consider new types of electrical energy storage. The vanadium redox battery uses charged, conductive, electrolyte fluids, which are often toxic or acidic and corrosive. Other research that uses the term “flowable battery” describes a flowable anolyte redox and is distinct from the electrical energy carriers suspended in a non-conducting fluid disclosed herein. For example, M. Youssary et al. describe the “Formulation of flowable anolyte for redox flow batteries: Rheo-electrical study” in volume 274 of the Journal of Power Sources, pp. 424-431 on 15 Jan. 2015.

U.S. Patent Application No. 2015/0129081 discloses a “Fuel System Using Redox Flow Battery” which is distinct from the system disclosed herein. This redox flow battery requires two oppositely charged ionic liquids, a “cathode slurry” and an “anode slurry” that are stored separately and flow near each other on opposite sides of a membrane as opposed to the single, non-conducting, inert liquid in the system disclosed herein. Neither slurry is a non-conductive fluid, as disclosed herein, since both are charged ionic fluids. While a detailed description is not publicly available, the ionic liquid system and redox flow cell described on the website of nanoFlowcell AG appears similar.

A nanoelectrofuel (NEF) battery uses suspensions of solid nanoparticles that act as a either an anode or a cathode rather than as a constructed battery cell, like the electrical energy carriers as disclosed herein. In addition, the NEF battery uses a liquid electrolyte to carry electrical energy when passing through customized redox flow cells as disclosed in U.S. Patent Application No. 2016/0126581.

Fast charging batteries, such as Li-Ion batteries that have been modified to be fast charging, have been suggested to reduce recharge time. For example, in a battery developed by Nanyang Technology University (NTU), the traditional graphite used for the anode in lithium-ion batteries is replaced with a titanium dioxide gel material as disclosed in Patent Cooperation Treaty Application No. PCT/SG2014/000435 and “Ultra-Fast Charging Battery Can Reach 70% in Only 2 Minutes”, Electric Vehicle News, Oct. 15, 2014. Naturally found in spherical shape, the NTU team transformed the titanium dioxide into tiny nanotubes, a thousand times thinner than a human hair. This speeds up the chemical reactions taking place in the NTU battery, allowing for fast charging. But fast charging still places too much stress on the existing power grid because it requires an electrical power source that can provide tens of kilo-amps of current in a short time for each EV being recharged.

The automobile industry currently installs EV batteries of different shapes, sizes and capacities. Electrical limitations to the recharge rate of these pre-installed battery packs result in long recharge periods. This is a significant hindrance to the adoption of EV's for long distance or ad hoc unplanned travel as the recharge period for an EV is far greater than the refueling time for a hydrocarbon fuelled internal combustion powered vehicle. Thus there remains a need for scalable, high-energy density and high power-density energy storage systems and a new refueling system, battery design, and charge/recharge technology is needed.

### SUMMARY

A pourable system for energy storage and transfer comprises a low friction non-conductive fluid, a plurality rechargeable electrical energy carriers suspended in the non-conductive fluid, and a means for transferring, via pressure, the non-conductive fluid and the rechargeable electrical energy carriers suspended therein from a storage container through an electrical energy transfer system. Each of the rechargeable electrical energy carriers lacks sharp edges and has a diameter of less than ten centimeters and an external surface including at least one orientation feature, a positive electrode, a negative electrode, and a sealed housing between the electrodes. The electrical energy transfer system is a discharge system. The storage container and discharge system are part of a mobile apparatus. The means for transferring the rechargeable electrical energy carriers suspended in non-conductive carrier fluid includes non-conductive pipes between the storage container and the electrical energy transfer system, a pressure source, and an alignment mechanism that interacts with orientation features of the electrical energy carriers to align them into a single layer with matching orientation in the non-conductive fluid. The single layer of electrical energy carriers passes through the electrical energy transfer system via a channel. The electrical energy transfer system also includes conductive plates on opposite sides of the channel to allow the single layer, impelled by pressure, to pass between the conductive plates and make electrical contact therewith. A control system handles electrical current transferred from or to the electrical energy carriers via the conductive plates.

A system for charging electrical energy carriers is also disclosed. The system includes a non-conductive fluid having a low coefficient of friction and maintaining electrical isolation between the electrical energy carriers suspended in it. Each of the electrical energy carriers is less than ten centimeters in diameter, shaped without sharp edges, and has a positive electrode, a negative electrode, a sealed housing, and at least one orientation feature. The orientation features of the electrical energy carriers are configured to assist alignment of the electrical energy carriers into a single layer with matching orientation in the non-conductive fluid. A pumping mechanism is used for loading non-conductive fluid containing discharged electrical energy carriers (EECs) into a first non-conductive container via non-conductive pipes. A second non-conductive container holds charged electrical energy carriers in non-conductive fluid. The system also includes at least one channel with a pair of charging plates disposed so as to allow the single layer of EECs to pass through the charging plates and into the second non-conductive container impelled by hydraulic pressure mediated by the non-conductive fluid. A means for off-loading charged electrical energy carriers in the non-conductive fluid from the second non-conductive container is also provided.

In some implementations the system comprises a plurality of electrical energy carriers each having a positive electrode, a negative electrode, a housing sealed to liquid, and at least one orientation feature, a first container for holding the electrical energy carriers in non-conductive fluid, a second container for holding discharged electrical energy carriers in non-conductive fluid, and at least one channel having discharge plates disposed on opposite sides of the channel so as to allow the single layer to pass from the first container, between the discharge plates and into the second container impelled by pressure. The non-conductive fluid assists in maintaining electrical isolation between the electrical energy carriers. The orientation features of the electrical energy carriers are configured to assist alignment of the electrical energy carriers into a single layer with matching orientation of each positive electrode. The system may also include a means for using the orientation features of the electrical energy carriers to align the discharged electrical energy carriers into a discharged layer with matching orientation, and at least one charging channel having charging plates disposed on opposite sides of the charging channel so as to allow the discharged layer to pass between the charging plates and into the first container impelled by pressure.

The system may further include a plurality of channels, each having discharge plates. The orientation features of the electrical energy carriers are used to align the electrical energy carriers into a plurality of single layers with matching orientation of each positive electrode and each single layer passes from the first container, between the discharge plates in the corresponding channel and into the second container impelled by pressure.

One orientation feature may be the shape of each electrical energy carrier. The shape of each electrical energy carrier may be ellipsoid and include an indentation, where either the positive electrode or the negative electrode is located in the indentation. The shape of each electrical energy carrier is an asymmetrical shape. The orientation feature may be one electrode comprising ferromagnetic material. The electrical energy carriers may be capacitors. The electrical energy carriers may be battery cells. The electrical energy carriers have rounded edges and are less than ten centimeters in diameter. The non-conductive fluid has a low coefficient of friction. The system includes a pumping mechanism for providing pneumatic pressure or hydraulic pressure and the pressure impels the electrical energy carriers through the channel having discharge plates and non-conductive pipes disposed between the channel and the first and second containers.

The system may be on an electric vehicle and the discharge plates may be electrically connected to an electrical drive system of the electrical vehicle. The system further comprises a means for off-loading discharged electrical energy carriers in the non-conductive fluid from the second non-conductive container. One of the discharge plates is provided with springs and configured to ensure electrical contact between each positive electrode in the single layer and the opposite discharge plate is provided with springs and configured to ensure electrical contact between each negative electrode of each electrical energy carrier in the single layer as said electrical energy carrier passes between the discharge plates.

### BRIEF DESCRIPTION OF THE DRAWINGS

FIG. 1 is a bar chart showing the energy density of different rechargeable battery chemistries.

FIG. 2 shows a container with a portion of one wall cut-away to show electrical energy carriers in random arrangement in non-conductive fluid within the container according to some embodiments.

FIG. 3A is a line drawing of a lenticular electrical energy carrier according to some embodiments.

FIG. 3B is a line drawing showing an arrangement of lenticular electrical energy carriers according to some embodiments.

FIG. 3C is a cross section of a lenticular electrical energy carrier according to some embodiments.

FIG. 3D is a perspective of a cut-away of a lenticular electrical energy carrier according to some embodiments.

FIG. 4 is a perspective drawing of a truncated conical electrical energy carrier according to some embodiments.

FIG. 5A is a line drawing of a spherical electrical energy carrier according to some embodiments.

FIG. 5B is a perspective drawing showing an internal view of a spherical electrical energy carrier according to some embodiments.

FIG. 5C is a cross section of a spherical electrical energy carrier according to some embodiments.

FIG. 5D is a perspective drawing of a spherical electrical energy carrier according to some embodiments.

FIG. 6 is a drawing showing a general view of a system for discharging electrical energy carriers in non-conductive fluid according to some embodiments.

FIG. 7 shows a detailed side view of a discharge system for electrical energy carriers according to some embodiments.

FIG. 8 is a drawing showing the sorting and discharge system for lenticular electrical energy carriers according to some embodiments.

FIG. 9 is a drawing showing lenticular electrical energy carriers approaching spring-loaded brushes, being impelled between spring-loaded brushes, and with electrodes in electrical communication with spring-loaded brushes of a discharge system according to some embodiments.

FIG. 10 is side view showing a multichannel routing, alignment and discharge system for lenticular electrical energy carriers according to some embodiments.

FIG. 11 is a block diagram schematic showing how a flowable battery may be used to provide electrical power to an electric vehicle according to some embodiments.

FIG. 12 is a table of battery chemistries and characteristics that may be used in some embodiments.

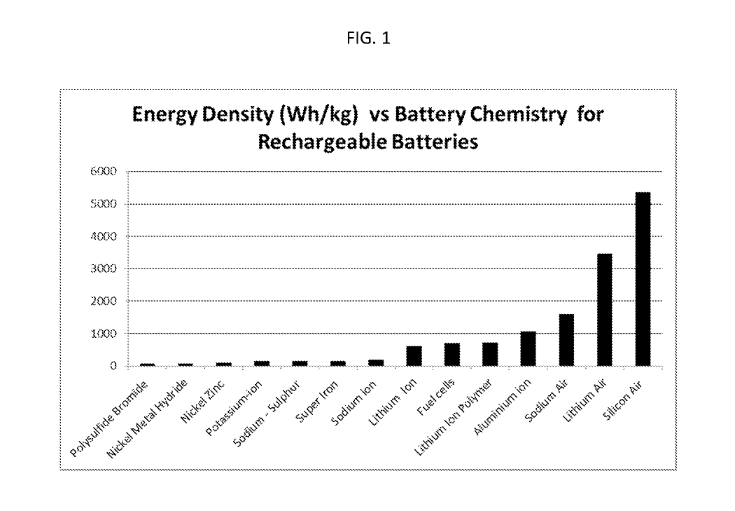

### DETAILED DESCRIPTION

A system and method that solves the problem of slow recharge times for electric vehicles (EVs) is disclosed. The disclosure may be understood with reference to the following detailed description in connection with the drawings. It is to be understood that the invention is not limited to the specific products, methods, conditions or parameters described and/or shown herein and that the terminology used is for the purposes of describing particular embodiments by way of example. Similarly, unless specifically stated otherwise, any description as to a possible mechanism, mode of action, or reason for improvement is meant to be illustrative only and the invention disclosed herein is not to be constrained by the correctness or incorrectness of any such suggested mechanism, mode of action, or reason for improvement. Descriptions refer both to devices and the methods of using the devices.

Throughout this disclosure, the singular forms “a”, “an”, and “the” include the plural reference, and reference to a particular numerical includes at least that particular value unless context clearly indicates otherwise. For example, a reference to “a container” is a reference to at least one such container known to those skilled in the art.

When values are expressed as approximations by use of the descriptor “about”, it will be understood that the particular values forms an embodiment. In general, the term “about” indicates approximations that can vary depending on the desired properties sought to be obtained and is to be interpreted in the specific context in which it is used, based on the function of the element and/or parameter described, and the person skilled in the art will be able to interpret the term “about” accordingly. In some cases, the number of significant figures used for a particular value may be a non-limiting method for determining the extent of the term “about”. In other cases, the gradations in a series of values may be used to determine the intended range for each value indicated by the term “about”. Where ranges are present, all ranges are inclusive and combinable. That is, a reference to a value stated in ranges includes each and every value within that range.

Certain features of the invention, which are, for clarity, described herein in the context of separate embodiments, may also be provided in combination in a single embodiment. Alternately, certain features, which are, for brevity, described in the context of a single embodiment, may also be provided separately or in any subcombination in some embodiments. Similarly, while a series of steps or part of a more general composition or structure may be described, each step or part may also be considered an independent embodiment in itself.

The flowable battery disclosed herein can be quickly loaded into a vehicle and as quickly offloaded when discharged, e.g. via conventional liquid filling stations or by swapping a charged fuel tank for a discharged tank. One aspect of the flowable battery disclosed herein is the non-stationary (having pourable, movable, or flowable properties with respect to the corresponding charging and discharging system) solid or semi-solid composition comprising electrical energy carriers (EECs) in a non-conductive fluid, or EEC slurry. As used herein, unless otherwise specifically indicated, the terms “electrical energy carrier” and “EEC” include both devices wherein energy is stored (i.e. a battery's internal electrolyte holds electrochemical potential and/or a capacitor's electrodes are charged) or harvested (i.e. a battery's internal electrolyte has been discharged and/or a capacitor's electrodes are discharged). The flowable battery composition conforms to any container shape, can be transported via pipes, is divisible and can be merged with or added to other flowable batteries of a similar type. Spent flowable battery fuel can be replaced and/or the quality and properties of the flowable battery can be varied from filling to filling to provide additional versatility or functionality. Energy densities of the EECs are similar to that of current battery technologies. The system and method may be optimized for different EECs as, for example, new battery cell sizes and internal chemistry are developed.

The present disclosure describes a system and method for transferring electrical energy to EVs in a way that improves the EV utility, e.g. the ratio of EV recharging time to drivable range and the daily drivable range. The problems of recharging time, range, and vehicle utility limit adoption of EVs. These problems will continue to exist, even with large capacity “super chargers” and rapid recharge capable battery packs. The limits on recharge time and battery pack capacity cap the ratio of EV recharging time to drivable range and daily drivable range for EVs.

These limitations remain in place while the conventional method of recharging via electrical cable connection remains the only method available to ‘fill up’ an EV with charged electrons. To replicate the energy flow rate of pumping gasoline into a hydrocarbon-fueled vehicle would require an immensely powerful electrical connection. When pumping gasoline, a vehicle with a 15 U.S. gallon gasoline capacity receives approximately 501 kWh of stored energy. To provide 501 kWh of stored energy through an alternating current connection of 415 V in 1.5 minutes would require a minimum 48 kilo-amp charging capability (i.e. a dedicated 20 MW electrical power source). This creates a significant and impractical load on the cable connection to the EV when recharging. In addition, cable recharging is a significant load on the local electrical grid (particularly for multiple EVs) and limits the feasibility of widespread adoption of rapidly recharged EVs.

The system disclosed herein loads many small electrical energy carriers (EECs, e.g. battery cells or individual capacitors) onto an EV instead of recharging a fixed battery via an electrical cable in order to provide more efficient and rapid energy transfer. For example, a user may load, via pumping, about 100 kg of EEC slurry (about 80 kg of EECs and about 20 kg of non-conductive fluid in which they are suspended) in about 5 minutes.

When pumping gasoline, about 334 kWh of energy is transferred to the vehicle in one minute. Those skilled in the art will be aware that not all fuel, fuel pumps, or users are identical, so, in practice, the gasoline energy-loading rate will vary. If small Li-Ion battery cells are pumped into a vehicle according to the system disclosed herein, the flowable Li-Ion battery energy-loading rate is about 9.34 kWh/min. While this is significantly slower than gasoline fueling it is still faster than a 50 kW charger, which loads energy at about 8.3 kWh/min. If small EECs with a greater energy density than Li-Ion batteries are pumped into a vehicle, the energy-loading rate will be correspondingly greater. For example, a flowable Si-Air battery according to the system disclosed herein corresponds to an energy-loading rate of about 68.6 kWh/minute. This is over 20% of the gasoline energy-loading rate and significantly faster than a 50 kW charger. For the sake of calculation, an 80% spacing efficiency (20% void space filled by the non-conductive carrying fluid) and 80% yield rate (20% failed or dead cells) is assumed. However, in some implementations, the spacing efficiency and/or yield rate may be different. In preferred embodiments, a higher yield rate may be achieved, however for this calculation, a yield rate of 80% live cells is assumed. Thus, providing electrical energy by loading small EECs (e.g. small battery cells or capacitors) onto a vehicle offers is faster than coupling a vehicle electrically to a charger and pumping electrons in via an electrical cable.

Another advantageous effect of the flowable battery system disclosed herein is that it solves the problem of lack of grid capacity to support many EVs charging simultaneously from a common electric grid. A single 50 kW charger is a reasonable load but a parking lot with many 50 kW chargers would require significant upgrades in terms of substations, transformers and grid supply. However, the flowable EECs (e.g. battery cells or capacitors) disclosed herein can be charged at the filling stations or charged near conventional power generating stations or alternative energy supplies, such as photovoltaics, wind turbines, or wave or tidal generators, and then transported to filling stations.

In “An Advanced Lithium-Air Battery Exploiting an Ionic Liquid-Based Electrolyte” Nano Lett., 2014, 14 (11), 6572-6577 and Patent Cooperation Treaty Application No. PCT/EP2015/060339, Elia and Bresser et al. disclose a Li-Air battery which may be used in the EEC slurry disclosed herein in some embodiments. In “Silicon-Air Batteries” Electrochemistry Communications, 2009, 11 (10), 1916-1918, Cohn et al. disclose a Si-Air battery which may be used in the EEC slurry disclosed herein in some embodiments. Liu and Rubloff et al. disclose “An all-in-one nanopore battery array”, Nature Nanotechnology, 2014 and U.S. Patent Application No. 2015/0200058 which may be used in the EEC slurry disclosed herein in some embodiments.

Disclosed herein is a system for flowable electric energy storage and use. Electric energy is stored in electrical energy carriers (EECs), such as battery cells or capacitors, suspended in a non-conductive fluid, thereby forming a flowable battery or EEC slurry. The EECs are relatively small, shaped without sharp edges, and designed with orientation, or polarization, features or to be self-aligning. Without sharp edges, the EECs will not interlock or bind to each other when suspended in non-conductive fluid or flowing through the system. Various implementations encompass EECs having mean EEC diameters of less than about 10 cm, less than about 10 mm, less than about 1 mm, less than about 0.1 mm, and less than about 1 nm or 0.8 nm. More specific implementations include those with a range of mean EEC diameters having an upper limit of about 10 mm, 1 mm, and 0.1 mm and lower limits of about 7 mm, 0.7 mm and 0.07 mm or any logical combination of such upper and lower limits. For example, non-limiting illustrative examples include implementations wherein the EECs have mean EEC diameters of about 0.7 mm to about 1 mm or about 0.07 mm to about 0.01 mm. Even smaller mean EEC diameters, down to nanometer-sized EECs may also be implemented. The size of the EEC is selected based on optimization of the ratio between EEC size and electrical characteristics, such as energy density. One skilled in the art will appreciate the trade-offs to be made when optimizing EEC size, however there is a practical minimum to the size at which an EEC can practically be manufactured. In some embodiments, a nano-carbon tube style design may be preferred.

The EEC orientation features may be mechanical and/or magnetic, or any other means of orienting the EECs so that positive electrodes are oriented in the same way and negative electrodes are oriented in the same way. These EECs are contained in a non-conductive carrying fluid, forming a slurry or suspension. The non-conductive fluid aids in lubricating the movement of the cells, cools the electrical energy carriers and associated charging/discharging mechanism, and assists in maintaining electrical isolation to prevent short circuits.

The electrical energy carriers are loaded into a non-conductive container in the EV via non-conductive pipes and/or tubes. The size of the non-conductive container may be determined by the energy requirements of the EV, for example a larger EV may require a larger container. When electrical power is required the EECs flow or are pumped into a discharge system where they are electrically discharged into the EV's electrical system. The system aligns the cells into a single layer with matching orientation before they pass between discharge plates. In some embodiments, discharge plates are arranged in multiple channels, so aligned single layers of cells may be distributed across the multiple channels, following multiple pathways through the discharge plates. Then they are electrically discharged into the EV electrical system. Following discharge the electrical energy carriers are pumped into a non-conductive onboard container for storage until they can be offloaded. At refilling time the discharged EECs (in the non-conductive carrying fluid) are discharged into a filling station. These EECs are then recharged and checked for serviceability by automated recharging machinery. Recharged and serviceable EECs may then be dispensed at a filling station to be reused by other customers. The charging system is the reverse of the discharging system, where the uncharged cells are sorted and aligned before passing between charging plates and flowing into a non-conductive holding tank.

The discharge and charging systems (comprising discharging plates and charging plates) are uniquely designed for the shape, size, and electrical characteristics of the electrical energy carriers (EECs). As used herein, unless otherwise specifically indicated, the terms “discharging plate(s)”, “discharge plate(s)”, “charging plate(s)”, “recharging plate(s)” and “recharge plate(s)” include one or more pairs of plates or other contact based systems for transferring electrical charge, such as brushes and/or commutators, a v-shaped groove, and/or spring-loaded contacts, including spring-loaded plates. Technology embodied by the EEC may change but the discharging and charging plates must be adapted for each particular EEC configuration to ensure reliable electrical contact. The shape, size, contacts, and electrochemistry of the EECs will determine the best design for the discharging and charging plates.

Various implementations will now be described more fully with reference to the drawings. The systems and methods disclosed may, however; be implemented in different forms and should not be construed as limited to the embodiments set forth herein. Rather, the implementations described herein are provided so that this disclosure is thorough and complete and conveys the inventive concept to those skilled in the art. In the drawings, the sizes and/or relative sizes of elements and regions may be exaggerated for clarity.

According to the system disclosed herein, EV recharging is not done via electrical connection, instead small electrical energy carriers (EECs) are pre-charged and the EV is mechanically filled with the EEC slurry, creating a flowable battery. The EEC slurry, as used herein, is a mixture of solid EECs and non-conductive fluid in liquid phase, and may also be described as a semi-solid, particle suspension, heterogeneous mixture, or colloidal suspension. In preferred embodiments, the EECs are rechargeable. In some implementations of the system, the EECs suspended in the non-conductive fluid may be small capacitors, such as super-capacitors, ultra-capacitors, electrochemical or electric double-layer capacitors (EDLCs), micro-capacitors, or nano-capacitors. In other implementations, the EECs may be small battery cells, such as micro- or nano-cells. Some implementations use fast charging batteries or cells, such as the modified Li-Ion battery disclosed by Nanyang Technological University in, e.g. Patent Cooperation Treaty Application No. PCT/SG2014/000435, as EECs to create a flowable battery according to the system disclosed herein which allows EVs to refuel quickly without stressing the existing power grid.

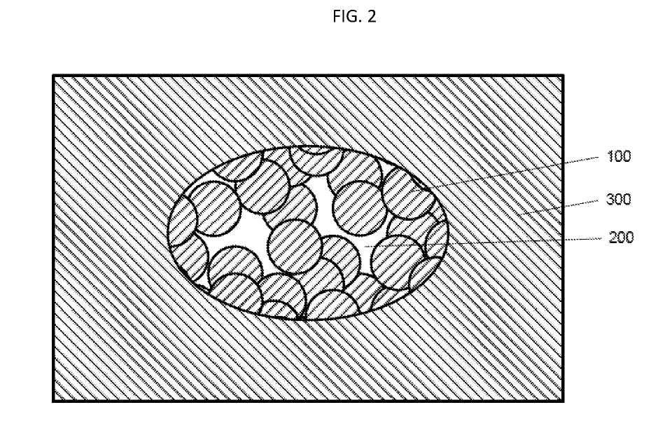

FIG. 2 shows a non-conductive container 300 with a window 310 cut away to show EECs 100 in non-conductive fluid 200 inside the container 300. In some implementations the EECs 100 may be micro-cells, suspended in fluid 200 and separated by a microfilm of the battery transport fluid 200. The EECs 100 are unsorted and suspended in fluid 200 in a randomized manner. The EECs 100 are randomly arranged as they may be stored onboard the EV or in the recharging or refilling station. As can be seen from FIG. 2 the thickness of the layer of fluid 200 between any pair of EECs 100 may vary. The container 300 may be located on an EV or in a refilling or recharging station. The EECs 100 are separated by a layer of non-conductive fluid 200 to prevent short circuits and are immersed the same fluid 200. A primary function of the fluid 200 is to allow the EECs 100 to be moved hydraulically through pipes, containers and storage vessels, and chutes. In this way, the solid EECs 100 can be moved with the fluid 200 and delivered like a liquid suspension or slurry rather than as a solid. As one skilled in the art would be aware, when carrying the EECs 100, the fluid 200 cannot be forced through any orifice smaller than the size of the EECs 100. The fluid 200 also provides electrical insulation between the EECs 100 so an electrically nonconductive fluid is required by the system disclosed herein. A secondary function of the fluid 200 is to transfer heat away from the EECs 100 and the charging and discharging mechanisms, thereby aiding in cooling.

Containers and tanks for use in the system may be any size or shape. In some preferred implementations, storage tanks are configured to minimize damage to electrical energy carriers due to crush weight of the electrical energy carriers and the non-conductive fluid. In some implementations, the storage tanks are configured to serve as a swappable fuel tank in an EV with a configuration allowing the tanks to be easily removed from the EV and exchanged for a full tank. In preferred implementations, the EECs are stored in sufficient non-conductive fluid to prevent accidental electrical connection and discharge during storage. In some preferred implementations, the non-conducting fluid is stable over the long term and its insulating and lubrication properties do not significantly degrade over time.

The shape of the EECs 100 is designed for easy flow with the aid of hydraulics. The electrical energy carriers are capable of flowing through the flowable battery system disclosed herein. EECs 100 may be conical, spherical, or shaped in any way such that the EECs will not lock or bind together while flowing through the system suspended in the non-conductive fluid 200. In some embodiments, the shape of the electrical energy carriers may be biomimetic, for example they may be lenticular, fabiform, reniform, torroidal, or ellipsoid.

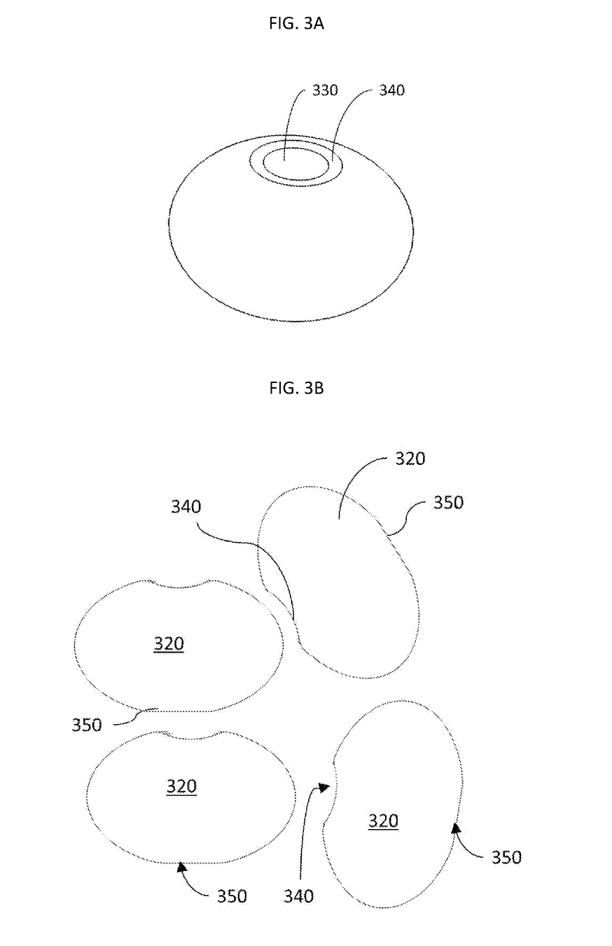

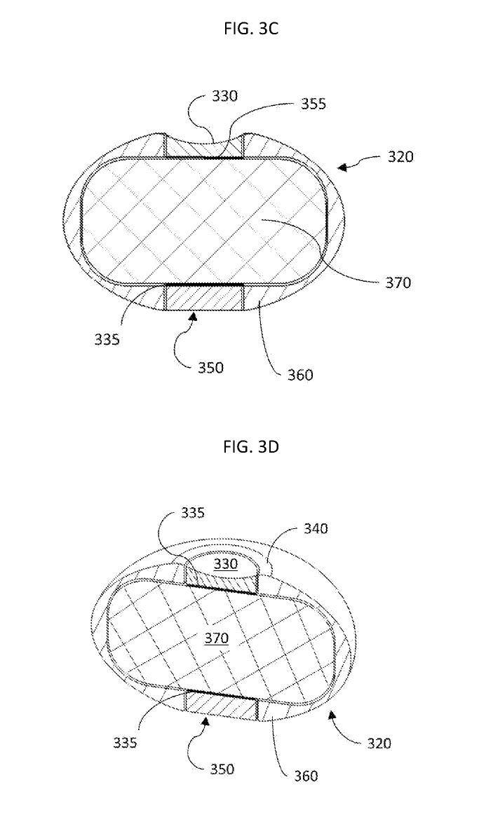

FIG. 3 shows one possible biomimetic EEC shape. FIG. 3A is a line drawing of a lenticular electrical energy carrier 320 according to some embodiments. In some implementations, the EEC may be a micro-cell with an ellipsoid or lenticular shape. A lenticular EEC may self-orient because the EEC shape assists in orientation in conjunction with the physical arrangement of the system. The EEC 320 shown comprises three external components:

1) A positive metal contact 330, or positive electrode, on one side. In FIG. 3A, the positive electrode 330 is on top of the EEC 320 inside the indentation 340 to mechanically aid orientation and prevent accidental discharge or short circuits caused by unintended electrical connection.

2) A negative metal contact 350, or negative electrode, on the opposite side is indicated in FIG. 3B but not visible in FIG. 3A. In the implementation shown, the negative electrode 350 is on the flattened bottom of the EEC 320. In alternate cases, the negative electrode is in an indentation 340 and the positive electrode is on the opposite side of the EEC. Differences in the physical size and shape of the positive and negative electrodes assist in mechanical sorting and orientation.

3) An external cover 360 between the positive electrode 330 and the negative electrode 350 is non-conductive and impermeable to liquid. In some implementations, the external cover 360 has a polymer coating. In some implementations, the external cover 360 is composed of a polymer. The indentation 340 and lenticular shape of the external cover 360 aids orientation within the charging and discharging mechanisms.

FIG. 3B is a line drawing showing an arrangement of lenticular EECs 320 suspended in non-conductive fluid. The lenticular shape and indentation 340 prevents positive electrodes 330 from coming into contact with each other or any negative electrode 350. Instead, the indentation 340 only allows the maximally curved portion of the non-conductive housing 360 to nestle into the positive electrodes 330, thereby aiding the prevention accidental discharge or short circuits caused by unintended electrical connection.

FIG. 3C is a cross section of a lenticular electrical energy carrier 320 showing interior features of the EEC 320 in relation to the positive electrode 330, housing 360, and negative electrode 350. In some implementations, the EECs 320 may be battery cells having internal components vary depending on selected battery chemistry for a particular implementation. Typically EECs include a negative terminal, or anode 355, positive terminal, or cathode 335, and electrolyte, ion transport medium, or dielectric 370. The negative terminal 355 is in electrical communication with the negative electrode 350 and the electrolyte, ion transport medium, or dielectric 370. Similarly, the positive terminal 335 is in electrical communication with the positive electrode 330 and the electrolyte, ion transport medium, or dielectric 370.

FIG. 3D is a perspective of a cut-away of a lenticular EEC 320. As can be appreciated from the drawing, the majority of the volume of the EEC 320 comprises the electrolyte, ion transport medium, or dielectric 370. In some implementations, ionic fluids may be used as a replacement for water-based electrolytes 370 inside battery cells. In some implementations, ionic fluids may be used inside Li-Air cells. In some implementations, the housing 360 may be injection molded around a positive electrode 330 in electrical communication with the positive terminal 335 of a commercially available battery cell or capacitor and a negative electrode 350 in electrical communication with the negative terminal 355.

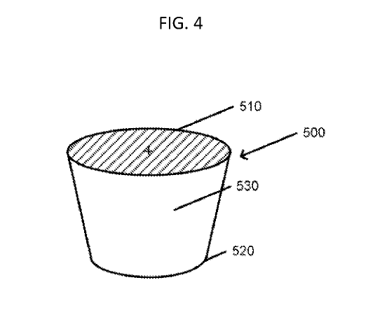

FIG. 4 shows one possible EEC shape. In some implementations, the EEC may be a micro-cell with a truncated conical shape. A truncated conical EEC may self-orient because of the EEC shape assists in orientation in conjunction with the physical arrangement of the system. The EEC 400 shown comprises three external components:

1) A positive metal contact 410, or positive electrode, on one side. In FIG. 4, the positive electrode 410 is the larger side of the EEC 400. In some implementations, the positive electrode is also shaped to mechanically aid orientation, for example it may be indented or include a protrusion.

2) A negative metal contact 420, or negative electrode, on the opposite side of the EEC 400 is indicated but not visible in FIG. 4. In the implementation shown, the negative electrode 420 is smaller than the positive electrode 410. In alternate cases, the negative electrode is the larger electrode and the positive electrode is smaller. In some implementations, the negative electrode is shaped differently from the positive electrode, for example it may be indented while the positive electrode protrudes from the plane. Differences in the physical size and shape of the positive and negative electrodes assist in mechanical sorting and orientation.

3) An external cover 430 is non-conductive and impermeable to liquid. In some implementations, the external cover 430 has a polymer coating. In some implementations, the external cover 430 is composed of a polymer. The conical shape aids orientation within the charging and discharging mechanisms.

In some implementations, the EECs 400 may be battery cells having internal components vary depending on selected battery chemistry for a particular implementation. Typically EECs include a negative terminal, or anode, positive terminal, or cathode, and electrolyte, ion transport medium, or dielectric. The negative terminal is in electrical communication with the negative electrode and the electrolyte, ion transport medium, or dielectric. Similarly, the positive terminal is in electrical communication with the positive electrode and the electrolyte, ion transport medium, or dielectric.

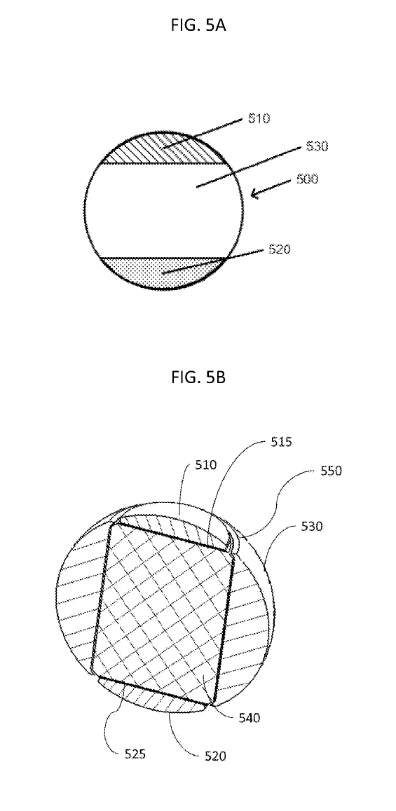

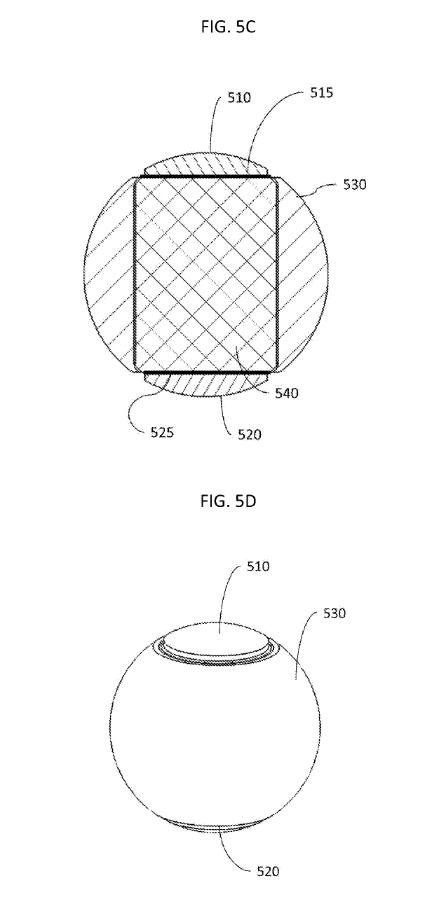

FIG. 5 shows another possible EEC shape. In some implementations, the EEC may be a spherical micro-cell. FIG. 5A is a line drawing of a spherical EEC 500. The EEC 500 shown includes magnetic orientation features and comprises three external components:

1) A positive metal contact 510, or positive electrode, on one side. This side of EEC 500 is shaped similarly to the negative side. In this implementation, the positive electrode 510 is made from steel or another ferromagnetic metal as a magnetic orientation feature allowing the use of magnets to align the EEC 500 according to the required orientation and aid in EEC location.

2) A negative metal contact 520, or negative electrode, on the opposite side of the EEC. In this implementation, the negative electrode is made from a non-ferromagnetic metal in order to allow the use of magnets to align the EEC 500 according to the required orientation. In some implementations, the negative electrode 520 may be smaller or shaped opposite to the positive electrode 510 to provide additional assistance in mechanical sorting and orientation.

3) A non-conductive external cover or housing 530 that is impermeable to liquid. In some implementations, the external cover 530 has a polymer coating. In some implementations, the external cover 530 is composed of a polymer.

FIG. 5B is a perspective drawing showing interior features of the spherical EEC 500 in relation to the positive electrode 510, housing 530, and negative electrode 520. In some implementations, the EECs 500 may be battery cells having internal components vary depending on selected battery chemistry for a particular implementation. Typically EECs 500 include a negative terminal, or anode 525, positive terminal, or cathode 515, and electrolyte, ion transport medium, or dielectric 540. The negative terminal 525 is in electrical communication with the negative electrode 520 and the electrolyte, ion transport medium, or dielectric 540. Similarly, the positive terminal 515 is in electrical communication with the positive electrode 510 and the electrolyte, ion transport medium, or dielectric 540. The non-conductive external cover 530 may form a lip or break 550 around the positive electrode 510 and the negative electrode 520.

FIG. 5C is a cross section of a spherical EEC 500. As can be appreciated from the drawing, the majority of the volume of the EEC 500 comprises the electrolyte, ion transport medium, or dielectric 540. In some implementations, ionic fluids may be used as a replacement for water-based electrolytes 540 inside battery cells. In some implementations, ionic fluids may be used inside Li-Air cells. In some implementations, the housing 530 may be injection molded around a pre-assembled sandwich comprising the positive electrode 510 in electrical communication with the positive terminal 515 of a commercially available battery cell or capacitor and a negative electrode 520 in electrical communication with its negative terminal 525.

FIG. 5D is a perspective drawing of a spherical EEC 500 showing the positive electrode 510 and the negative electrode 520 with the housing 530 extending therebetween.

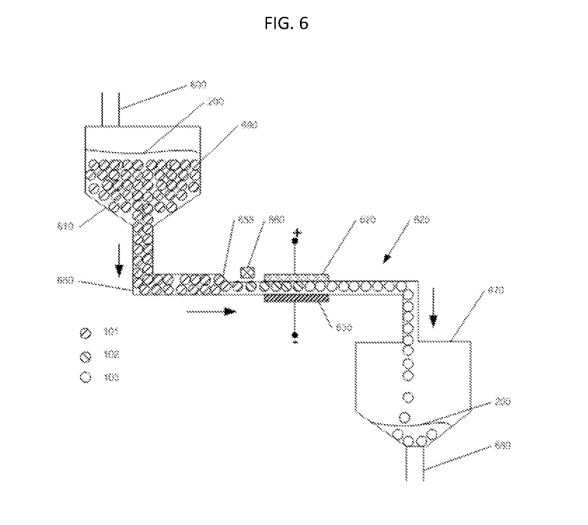

FIG. 6 is a drawing showing a general view of a system for discharging electrical energy carriers in non-conductive fluid according to some embodiments. Charged EECs 101 may enter the system with randomized and unsorted orientations and arrangements through a spout 600. The system is configured to sort and arrange charged EECs 101 suspended in fluid 200 before they flow between the discharging plates 620 and 630. FIG. 6 shows one system for mechanically and magnetically arranging EECs 101 while moving through the system so the charged EECs 101 can be automatically discharged. FIG. 6 shows a simple sorting and orientation mechanism according to some implementations. The flow direction is indicated in the figure by the arrows. Gravity, fluid pressure, and/or the physical configuration of a funnel 610 may act as a sorting mechanism, to sort the EECs into a single layer. In FIG. 6, the EECs 101 flow through a first funnel 610 at the base of the first container 615 and a second funnel 655 in the non-conductive pipe 650 between the first container 615 and the discharge plates 620 and 630 to form a single layer of EECs 101. The EECs 101 are the oriented magnetically with magnet 660 that arranges the EECs 101 into a polarized, consistently oriented, linear arrangement, with positive electrodes pointing toward the positively connected discharge plate 620 and negative electrodes pointing towards the negatively connected discharge plate 630. The magnet 660 may be a permanent magnet, such as a rare earth magnet, or an electromagnet. In FIG. 6, the EECs 101, 102, and 103 are provided with a positive steel or ferromagnetic electrode that is attracted to magnet 660. In alternated embodiments, the steel or ferromagnetic electrode may be the negative electrode. The EECs 101 are aligned with a single orientation as fluid pressure pushes the EECs 101 into the narrow tube past the funnel 655 and magnet 660. In some implementations, funnels may be oriented vertically and a heavier end of each EEC is aligned towards the bottom of the funnel. The fluid 200 is used to provide positive pressure as well as lubrication. In alternate embodiments, gravity may assist with alignment or provide the primary force by which EECs 101 are aligned in the sorting mechanism. Once the charged EECs 101 are oriented in a single layer, positive electrodes are electrically connected to the positively connected discharge plate 620 and negative electrodes are electrically connected the negatively connected discharge plate 630 in order to form a circuit, partially discharging the EECs 102. In some embodiments, there are multiple discharge plates 620 and 630, each partially discharging the EECs 102, until the fully discharged EECs 103 finish passing through the discharge plates 620 and 630 and flow through a non-conductive pipe to a second container 670 for storing discharged EECs 103 until they can be offloaded for recharging via an off-loading spout 680.

FIG. 6 shows the physical flow of the EEC slurry as it may be implemented on a mobile apparatus such as an EV. In FIG. 6 the four major components of the system are shown: a first container or onboard tank 690 for holding fully charged electric charge carriers 101 in non-conductive fluid 200 or fuel tank 690; electric charge carriers 100; discharge system 625; a second container or onboard tank for holding discharged EECs 103 in non-conductive fluid 200 or holding tank 670. The fuel tank 690 containing fully charged EECs 101 in non-conductive carrying fluid 200 is connected via nonconductive pipes 650 to the discharge system 625 where the EECs 101 electrical potential is removed via discharge plates 620 and 630. As the EECs pass through the discharge plates 820 they are transformed from fully charged EECs 101 to partially discharged EECs 102 until all electrical potential is removed and they become fully discharged EECs 103. The discharged EECs 103 then flow to a discharged EEC tank 670 where they are kept in storage prior to discharging to a recharging or refilling station. The tanks may be fitted with spouts for filling and emptying, such as the filling spout 600 and discharge spout 680. The reverse of this process can be used for charging the discharged EECs 103 at a refilling or recharging station. The discharged EECs 103 flow or are pumped from a storage tank, through a charging or recharging system, to a tank for holding fully charged EECs 101.

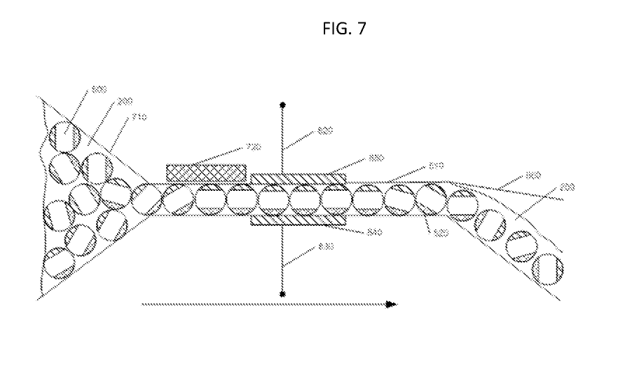

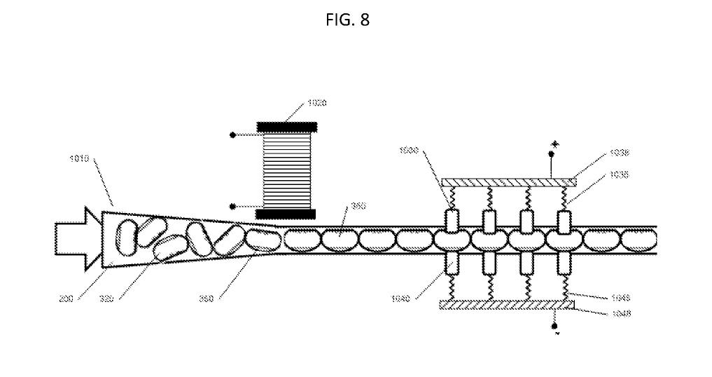

FIG. 7 is a detailed side view of a discharge system for electrical energy carriers according to some embodiments. The EECs 500 in the non-conductive fluid 200 start in the wide portion of funnel 710 with randomized and unsorted orientations and arrangements. The flow direction is indicated in the figure by the arrow. The fluid 200 is used to provide positive pressure as well as lubrication. Fluid pressure, in combination with the physical configuration of funnel 710 acts as a sorting mechanism, to sort the EECs 500 into a single layer. Then, the single layer of EECs 500 is the oriented magnetically with magnet 720 to arrange the EECs 500 into a polarized, consistently oriented, linear arrangement prepared for charging, recharging or discharge, as shown. The magnet 720 may be a permanent magnet, such as a rare earth magnet, or an electromagnet. In FIG. 7, the EECs 500 are provided with a positive steel or ferromagnetic electrode that is attracted to magnet 720. In alternate embodiments, the steel or ferromagnetic electrode may be the negative electrode. Other possible sorting mechanisms include physical and magnetic mechanisms to rotate, align and orient the EECs automatically as they flow through the system. Those skilled in the art will appreciate that industrial process design allows for multiple approaches to routing, alignment, and orientation. Magnetic sorting mechanisms include arrangements of one or more magnets that orient the EECs so that the positive electrode is aligned with the positive charging or discharging plate.

Once the EECs 500 are oriented in a single layer, positive electrodes 510 are electrically connected to the positively connected discharge plate 850 and negative electrodes 520 are electrically connected to the negatively connected discharge plate 840 in order to form a circuit, discharging the EECs 500. In some implementations, there are multiple discharge plates 840 and 850 to ensure the EECs 500 are fully discharged when they finish passing through the discharge plates 840 and 850. In some implementations, the discharge plates 840 and 850 are spring loaded to ensure electrical contact with the EECs 500. In some implementations, other contact based systems for transferring electrical charge, such as brushes and/or commutators, a v-shaped groove, and/or spring-loaded contacts are used to instead of or in addition to the discharge plates 840 and 850. When discharged, the EEC slurry comprising EECs 500 and non-conductive fluid 200, flows through a non-conductive pipe to a second container 860 for storing discharged EECs 500 and non-conductive fluid 200. The second container 860 may be any shape appropriate for the particular implementation of the system.

FIG. 8 is a detailed drawing showing the sorting and discharge system for lenticular EECs 320 according to some embodiments. The EECs 320 in the non-conductive fluid 200 start in the wide portion of funnel 1010 with randomized and unsorted orientations and arrangements. The flow direction is indicated in the figure by the arrow. The fluid 200 is used to provide positive pressure as well as lubrication. Fluid pressure, in combination with the physical configuration of funnel 1010 acts as a sorting mechanism, to sort the EECs 320 into a single layer. Then, the single layer of EECs 320 is the oriented magnetically with magnet 1020 to arrange the EECs 320 into a polarized, consistently oriented, linear arrangement prepared for charging, recharging or discharge, as shown. The magnet 1020 is shown as an electromagnet in FIG. 8, but in alternate implementations may be a permanent magnet, such as a rare earth magnet. In FIG. 8, the EECs 320 are provided with a positive steel or ferromagnetic electrode 330 that is attracted to magnet 1020. In alternated embodiments, the steel or ferromagnetic electrode may be the negative electrode. Other possible sorting mechanisms include physical and magnetic mechanisms to rotate, align and orient the EECs automatically as they flow through the system. Magnetic sorting mechanisms include arrangements of one or more magnets that orient the EECs so that the positive electrode is aligned with the positive charging or discharging brush. Those skilled in the art will appreciate that industrial process design allows for multiple approaches to routing, alignment, and orientation. Once the EECs 320 are oriented in a single layer, positive electrodes 330 are electrically connected to the positively connected discharge brushes 1030 and negative electrodes 350 are electrically connected to the negatively connected discharge brushes 1040 in order to form a circuit, discharging the EECs 500. FIG. 8 shows multiple discharge brushes 1040 and 1030 ensure the EECs 320 are fully discharged when they finish passing through the discharge brushes 1040 and 1030 and the discharge brushes 1040 and 1030 are spring loaded to ensure electrical contact with the EECs 320. The multiple discharge brushes 1040 and 1030 are each connected to corresponding springs 1035 and 1045. The springs 1035 and 1045 are preferred features to ensure electrical contact in charging and discharging systems for EECs, such as lenticular EEC 320, having one or more indented electrodes. The springs 1035 provide physical and electrical connection between the positive brushes 1030 and the positive physical and electrical contact element 1038, which is, in turn in electrical communication with at least one electric circuit to which the system provides electric power. The springs 1045 provide physical and electrical connection between the negative brushes 1040 and the negative physical and electrical contact element 1048, which is, in turn in electrical communication with at least one electric circuit to which the system provides electric power. One skilled in the art will appreciate that alternate embodiments reversing positive and negative poles or details of the electrical connections are possible. In some implementations, other contact based systems for transferring electrical charge, such as plates, commutators, a v-shaped groove, and/or other spring-loaded contacts are used to instead of or in addition to the discharge brushes 1040 and 1030.

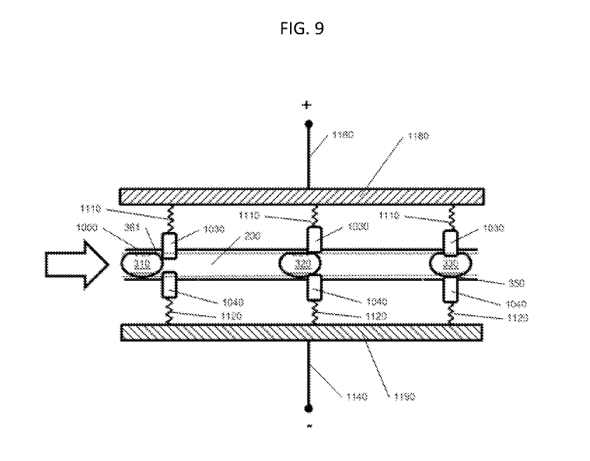

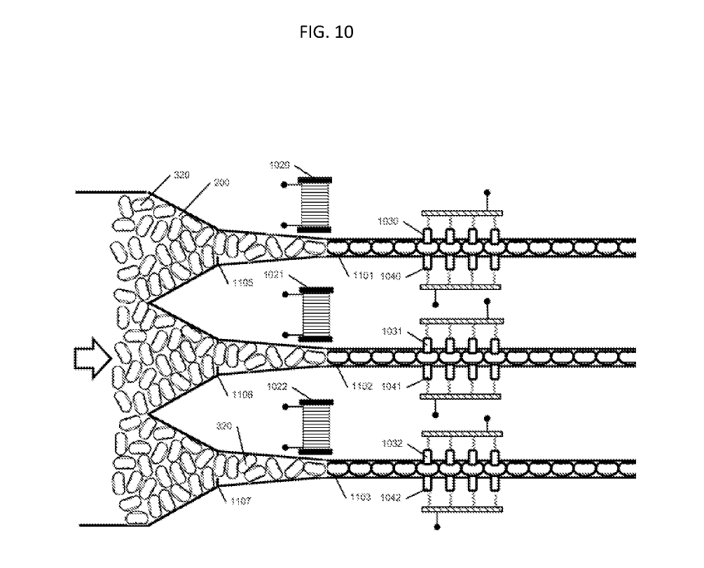

FIG. 9 is a drawing showing lenticular EECs 320 approaching spring-loaded brushes 1040 and 1030, being impelled between spring-loaded brushes 1040 and 1030, and with electrodes in electrical communication with spring-loaded brushes 1040 and 1030 of a discharge system according to some embodiments. The spacing between the lenticular EECs 320 is inconsistent to show different moments as the lenticular EECs 320 are impelled by pressure mediated by non-conductive fluid 200 to flow between the spring-loaded brushes 1040 and 1030, however, in preferred implementations the lenticular EECs 320 will be evenly spaced by the sorting and alignment mechanism when approaching the discharge system. The EECs 320 are impelled by pressure mediated by non-conductive fluid 200 to flow through a channel formed by a non-conductive pipe 1000. As an EEC 320 approaches spring-loaded brushes 1040 and 1030, the positively connected brush 1030 (shown here on the top of the non-conductive pipe 1000) makes contact with the upper forward curve of the EEC housing 361. As the EEC 320 flows in the direction indicated by the arrow the negatively connected brush 1040 will make also contact with the EEC housing 360. The brushes 1040 and 1030 are stiff and conductive, and in preferred implementations are made from sintered copper or bronze. Thus, as the EEC 320 is impelled between the brushes 1040 and 1030, the spring 1110 attached to brush 1030 is compressed and the spring 1120 attached to brush 1040 is compressed allowing the widest portion of the EEC 320 to pass between the brushes 1040 and 1030 as shown in the center of FIG. 10. The springs 1110 provide physical and electrical connectivity between the brushes 1030 and the positive physical and electrical contact element 1180, which is, in turn in electrical communication at a positive terminal 1160 with at least one electric circuit to which the system provides electric power. Similarly, springs 1120 provide physical and electrical connectivity between the brushes 1040 and the negative physical and electrical contact element 1190, which is, in turn in electrical communication at a negative terminal 1140 with an electric circuit to which the system provides electric power. The non-conductive fluid 200 continues to mediate pressure on the EECs 320, causing the EECs 320 to continue to flow in the direction indicated by the arrow, until the brushes 1030 and 1040 make electrical connection with the positive electrode 330 and the negative electrode 350 respectively, forming a circuit for discharge of the EEC.

FIG. 10 is side view showing a multichannel routing, alignment and discharge system for lenticular EECs 320 according to some embodiments. The EECs 320 in the non-conductive fluid 200 start in a first container or onboard tank 1199. Pressure may be applied in the direction indicated by the arrow via a pump (not shown) causing the EEC slurry to flow to the right. The EECs 320 in the non-conductive fluid 200 start in the first container 1199 with randomized and unsorted orientations and arrangements. The right end of the first container 1199 is configured in the form of multiple graduated funnels. Fluid pressure, in combination with the physical configuration of the funnels acts as a routing mechanism, diverting the EECs 320 into single layers within three channels 1101, 1102, and 1103. Those skilled in the art will appreciate that industrial process design allows for multiple approaches to routing, alignment, and orientation. For example, internal mechanisms 1105,1106,1107 in the funnels are designed to flip and orient the ferromagnetic side of the EECs upwards in each single layer before allowing the magnet pull the EECs into the correct orientation.

Flow paths in the charging and discharging systems may be selected from any configuration that provides suitable flow rates in the space available in the charging station, refilling station, mobile apparatus powered to be powered by the flowable battery, or EV. Flow paths need not be configured as shown in the exemplary figures. Alternate sorting mechanisms, routing mechanisms, diverter mechanisms may be provided to ensure the EECs flow through one or more charging or discharge channels. In some embodiments, more than 3 channels are used. In addition, alternate orientation mechanisms, and contact mechanisms may be chosen to maximize the yield, or percent of EECs that provide energy, when charging or discharging.

The charging and discharging paths may be configured in arrangements that differ from those shown in the exemplary figures. In some preferred implementations, the charging and discharging paths are configured to provide maximum current and voltage in the minimum time for both charging and discharging. In cases where the predetermined characteristics of the EECs require a longer charging and discharging time, the charging and discharging paths may be extended. For example, longer discharge tubes and/or additional or longer charging and discharging plates may be used. In some implementations, multiple discharging paths, for example three discharge paths are shown in FIG. 10, are configured to increase the availability of electrical energy. Similarly, multiple charging paths in a refueling station may be used to increase the rate at which discharged EECs may be recharged. In addition, preferred implementations are configured to maximize durability and repeatability when making discharging and charging connections. In some implementations, the discharging and charging paths are configured to pass through discharging and charging plate systems making automatic electrical contact with the EECs.

Flowable battery technology is used to fill and power the EV via multiple subprocesses including fueling, operation, emptying, and recharging discharged EECs. The electric vehicle refueling process begins when the EV enters the filling station. In some cases, a driver may enter the filling station when the EV needs refilling. In some implementations, a sensor indicates whether charged EECs remain in the onboard fuel tank or first container. If insufficient EECs remain, then the driver will be notified that the EV needs refueling. In other cases, a driver may enter the filling station at any convenient time. The refilling station includes a storage tank holding charged EECs in non-conductive fluid. In cases where the refilling station has no available charged EEC slurry in a storage tank, the driver may need to wait for the EEC recharging process to be completed. Non-conductive fluid with charged EECs is pumped from the fueling station storage tank into the first container or the tank onboard the EV for holding charged EECs.

When charged EECs are available in the first container onboard the EV, the EV may be driven or use the EECs as an electric power source. The EECs move onboard the EV as needed in a vehicle operation process including EEC discharge. After discharge, the EECs are stored in a second container or tank onboard the EV.

When the EV enters the filling station, discharged EECs are pumped, with non-conductive fluid from the second container for holding discharged EEC slurry on the EV. The discharged EECs are pumped from the second container into the refilling station tank for holding discharged EECs before the recharging process. Sequentially or simultaneously, non-conductive fluid with charged EECs may be pumped from the fueling station storage tank for charged EECs into the first container or the tank onboard the EV for holding charged EECs. Once the second onboard container holding discharged EECs is empty and the first container or the tank onboard the EV for holding charged EECs is full the driver may depart the refilling station. In some cases, the driver may choose to depart the filling station with partially depleted second container or partially filled first container.

Onboard the EV, EECs move in response to the power being required. Power may be required due to manual input from the driver or automatic input from the onboard control system. The onboard fuel tank, or first container holds charged EECs suspended in non-conductive fluid. When a signal indicating that electrical power is required is received, the EECs in non-conductive fluid are released from the tank and pumped to flow through non-conductive pipes to the channel with discharge plates in the EV. The discharge system includes discharge plates, which are in electrical communication with the electric motor, which is an electrical load. In some implementations, the discharge plates are also in electrical communication with other electrical systems of the vehicle via a control system. The EECs are discharged into the electrical load onboard the EV, providing power for motion and onboard electronics. After discharge at the discharge plates, the discharged EECs in the non-conductive fluid flow to a second container or holding tank onboard the EV. The discharged EECs remain in the holding tank until they can be offloaded. In some implementations, a sensor indicates how many charged EECs remain in the onboard fuel tank. If insufficient EECs remain, then the driver will be notified that the EV needs refueling. The operation and discharge processes causing EEC movement onboard the EV are repeated until the EV needs refueling, all or substantially all of the available charged EECs are discharged, or the driver chooses to refuel. Then the driver will enter the filling station.

The recharging process for electrical energy carriers starts when discharged EECs suspended in non-conductive fluid are offloaded from the EV, preferably into a storage tank at a refilling station. The discharged EECs may be processed and recharged at the refilling station or, in some implementations, the storage tank may be transported to recharging plant with recharging plates located near an electric power generator. The operator of the fueling station begins the automated recharging process. The discharged electrical energy carriers suspended in non-conductive fluid are pumped through non-conductive pipes to recharge plates for recharging. The discharged EECs are automatically aligned to form a discharged layer with matching orientation before flowing through at least one charging channel having charging plates disposed on opposite sides of the charging channel so as to allow the discharged layer to pass between the charging plates and into the first container impelled by pressure. At the charging or recharging plates, an electrical connection to the EECs allows power from the electrical grid to recharge the EECs. After passing through the recharge plates, the EECs pass into a second container for holding charged EECs at the fueling station. The EECs are tested to determine whether they are still capable of carrying a charge. If the electrical energy carriers are no longer viable, e.g. because of physical damage or degradation, they are passed into another storage tank for recycling. In some embodiments, the non-viable charge carriers are separated from the non-conductive fluid so that the fluid may be recycled within the system and the non-viable charge carriers are recycled separately. Recharged electrical energy carriers suspended in non-conductive fluid that are viable flow into a storage tank where they are held until loaded into an EV in a refueling process. In some embodiments, the storage tank may be transported from the recharging plant to a refueling station to satisfy distributed demand.

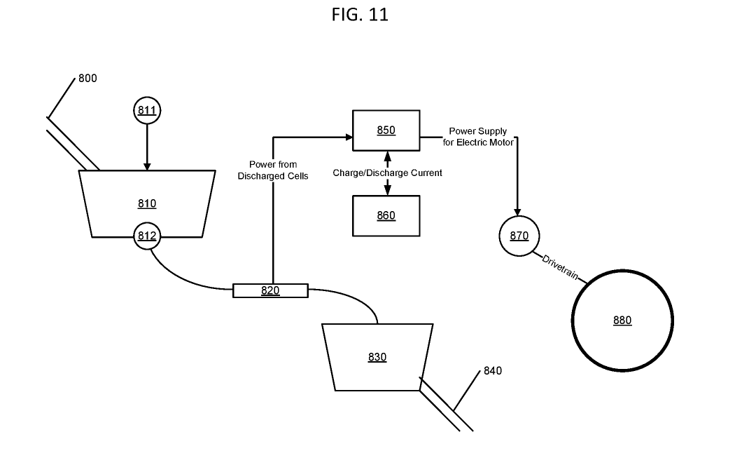

FIG. 11 shows the basic arrangement of the various systems in a flowable battery powered EV. This a block diagram showing the major components required for usage of a flowable battery in an electric vehicle. The diagram is not to scale. The non-conductive carrying fluid, including suspended EECs, is pumped through a filling spout 800 into a first container or fuel tank 810 onboard an EV. The fuel tank 810 is a closed container, similar to the non-conductive container 300, for holding charged EECs, and may have any size or shape desired for a particular implementation. When a signal from the control system 850 indicates that electrical power is required is received, the EECs in non-conductive fluid flow or are pumped through non-conductive pipes (indicated as lines without arrowheads in FIG. 11) to the discharge system in the EV. In preferred embodiments, the discharge system will include discharge plates 820. In the embodiment shown, an air pump 811 is used to provide positive air pressure to impel the EECs in the non-conductive fluid towards the discharge plates 820. A fluid pump 812 is provided near the exit point of the fuel tank 810 and is engaged, in combination with the air pump 811, when electrical power is required in order to pump the EECs suspended in non-conductive fluid towards the discharge plates 820. In alternate embodiments, gravitational pressure may be sufficient to ensure that the non-conductive fluid flows freely through the system when required. The configuration of the system shown in FIG. 11 generally shows that the second container or holding tank 830 is below the discharge plates 820, which are in turn below the first container or fuel tank 810. However, in some configurations gravitational force may not provide any significant impetus to the flow. In alternate implementations of the system, only one of a fluid pump or an air pump is required to ensure that the non-conductive fluid flows freely through the system when required.

After discharge in the channel between the discharge plates 820, the discharged EECs in the non-conductive fluid flow to a holding tank 830 onboard the EV where they are stored until they can be offloaded. The discharged EECs in the non-conductive fluid are offloaded from the EV via a discharge spout 840. The discharge plates 820 are electronically controlled by the power and battery control system 850, which distributes electric power from the discharged EECs as needed to loads of the electric vehicle. The power and battery control system 850 manages the flowable battery system to provide electric power to the EV by measuring and distributing electric power discharged at the discharge plates 820 to the EV's traction motor 870 and other required loads. The control system 850 also manages the pumps (air pump 811 and fluid pump 812) used to provide motive force for the flowable battery. The control system 850 is electrically connected to an onboard backup or reserve battery 860 and distributes power discharged from the flowable battery to recharge the reserve battery 860 as needed. The control system 850 also draws current from the reserve battery 860 as needed, for example when starting the system, operating the air pump 811 and fluid pump 812 to start flow in the system, or the like. The control system 850 also measures the flowable battery discharge rate and levels of charged EECs suspended in non-conductive fluid 200 in the fuel tank 810 and discharged EECs in non-conductive fluid 200 in the holding tank 830. The control system 850 also distributes power from the discharged EECs to an electric motor 870 to drive the drive train and cause the vehicle's wheels 880 to rotate as required for vehicle operation.

Various implementations of the control system 850 and associated methods described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language.

To provide for interaction with the user, the systems and techniques described here can be implemented on a computer, with or without a display device (e.g., a CRT (cathode ray tube) or LCD (liquid crystal display) monitor) for displaying information to the EV user and an input device, such as a keyboard or a pointing device (e.g., a mouse or a trackball) by which the user can provide input to the computer. Other kinds of devices can be used to provide for interaction with the user as well; for example, feedback provided to the user can be any form of sensory feedback (e.g., visual feedback, auditory feedback, or tactile feedback); and input from the user can be received in any form, including acoustic, speech, or tactile input.

In addition, other steps may be provided, or steps may be eliminated, from the described processes, and other components may be added to, or removed from, the described systems. Accordingly, other implementations are within the scope of the following claims.

Further, the control system 850 described herein may be implemented via a combination of hardware and software, as described, or entirely in hardware elements. Also, the particular division of functionality between the various system components described herein is merely example, and not mandatory; functions performed by a single system component may instead be performed by multiple components, and functions performed by multiple components may instead performed by a single component.

FIGS. 6-11 show how EECs flow through a discharging system to offtake the charge into a load. Charging of EECs reverses the process. The discharge mechanisms shown are examples of how EECs may be discharged into a load. The EECs are forced via hydraulic action into a channel where they are then orientated via one or more magnets. Once orientated, the EECs then come into contact with a positive discharge contact and a negative discharge contact, collectively discharge plates. The positive discharge contact is electrically connected to the positive terminal of the control system. The negative discharge contact is electrically connected to the negative terminal of thereby forming a circuit for discharging electrical power from the EECs. The partially discharged EECs continue to discharge while moving through the discharge system under hydraulic or fluid pressure. Once completely discharged, the discharged EECs are then free to flow into a discharged EEC tank or second container.

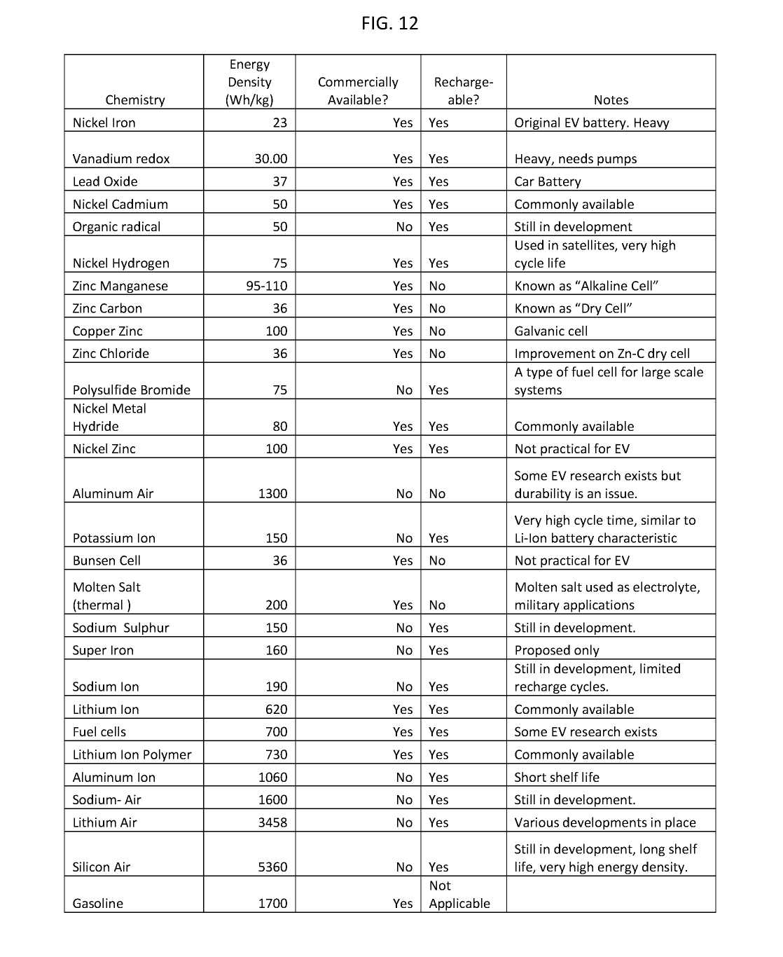

FIG. 12 is a table showing a selection of possible battery chemistries and characteristics. In preferred embodiments, energy density is maximized, charge rate is rapid, discharge rate is rapid, cost is low, and the chemistry is suitable for construction of a micro- or nano-size cell.

A small battery cell or capacitor can be constructed in such a shape as to be hydraulically transportable, electrically safe, and practically powerful. At present, a Si-Air EEC has the highest energy density available. Smaller Li-Air EECs are preferable to larger Li-Air EECs because the smaller size minimizes opportunities for contaminants to intrude into the EEC causing catastrophic failure. In addition, explosive effects caused by fast reaction speeds can more easily be contained for smaller EECs. One potential design for a Li-Air EEC is to surround the lithium metal anode with a nano-engineered cathode that provides a pathway for O₂ to reach the lithium metal anode and set up the potential difference. In some implementations the EECs are constructed in a microscopic hydraulically portable shape. Non-conducting fluid is used to hydraulically transport EECs from tanks through discharge and charging systems. The system disclosed herein may be used with any battery chemistry desired, and preferably with a battery chemistry that allows for a nano- or micro-cell hydraulically flowable EEC design, while maintaining sufficient energy density to improve the ratio of EV recharging time to drivable range and daily drivable range for EVs. In addition, preferable EEC designs will have a relatively short charging and discharging time. The charging and discharging of the EECs will be mediated by direct, physical conductor-to-conductor connection with charging and discharging plates, or the like. Preferred embodiments will use techniques that provide greater energy efficiency for the EEC shape and chemistry selected.

A range of possible shapes and terminal (contact) designs are possible. Preferred embodiments will use electrical energy carriers selected for suitability for hydraulic suspension and propulsion, long-wearing terminal design, and adequate terminal contact area to support maximum charge and discharge rates for the battery chemistry selected. In some implementations, one contact may be ferrous while the opposite contact is nonferrous to support magnetic orientation and/or polarization. In preferred embodiments the EEC size will be optimized based on battery chemistry.

In some implementations the electrical energy carriers are small battery cells capable of flowing when suspended in an electrochemically inert liquid. Commercially, cells on the scale of about 5 mm diameter are available and may be used as electrical energy carriers in the system disclosed herein. In some implementations EECs with about 1 mm or even smaller diameters may be preferred.

High energy density battery cells could be used as the electrical energy carriers disclosed herein. In some preferable embodiments, a Li-Air, Si-Air or Na-Air type battery chemistry may be used since these metal-oxygen batteries have the highest available energy density as seen in FIG. 12.

In some implementations the electrical energy carriers suspended in the non-conductive carrier fluid may be cells or capacitors constructed with carbon or other nanotubes. In some implementations nano-cells may be constructed inside nanotubes. A nanotube may be used for the non-conductive external cover of an EEC with the anode, electrolyte, or cathode created inside or around the nanotube. The nanotube may act as the either the anode or the cathode or as a container only. In some embodiments, two nested nanotubes may act as a nano-capacitor.

Disclosed herein is an energy storage system where electrical energy carriers such as battery cells or capacitors are small, shaped without sharp edges, and designed with orientation features. The orientation features may be mechanical or magnetic. These EECs are in are contained in a carrier fluid that is non-conductive and aids in lubricating the movement and electrical isolation of the EECs in order to prevent short circuits.

The EECs are loaded into a non-conductive container in the EV via non-conductive pipes and/or tubes. When electrical power is required the EECs flow into a discharge system where they are electrically discharged into the EV electrical system. Following discharge the EECs are pumped into a non-conductive onboard container. At refilling time the discharged EECs (in the non-conductive carrying fluid) are discharged into a filling station. These EECs are charged as well as checked for serviceability by automated recharging machinery in the filling station and are reused by other customers.

The discharge and charging systems (including charging plates or discharging plates) are uniquely designed for the EEC shape, size, and electrical characteristics. The EEC technology can change but this requires adaption of change of the discharge and recharge plates.

The system and method disclosed herein suspends small electrical energy carriers, such as battery cells or capacitors, in a non-conductive fluid. This allows rapid loading and unloading of cells in to an EV in a manner similar to normal hydrocarbon refueling. The EECs are poured into the vehicle with the assistance of positive pressure and gravity.

The carrier fluid in which the electrical energy carriers are suspended has the following four characteristics:

1) Temperature insensitivity. The fluid must remain stable and liquid at ambient temperatures from below freezing (approximately −100 degrees Celsius) to high temperatures (approximately 120 degrees Celsius).

2) Electrically non-conductivity. The fluid must act as electrical insulation or an electrical barrier between electrical energy carriers.

3) Viscosity. As long as the fluid is able to flow through the system, a wide range of viscosities are compatible with the system disclosed herein.

4) Low coefficient of friction. The coefficient of friction must be low enough that the electrical energy carriers can flow through the system without sticking and the fluid will not overheat during the charging or discharging process. The low coefficient of friction enables the fluid to act as a lubricant and help reduce wear and tear on the electrical energy carriers.

Any color of fluid is compatible with the system disclosed herein. In some preferred implementations, the fluid may additionally act as a coolant within the EV and/or refueling station. In addition, the non-conductive carrier fluid is used to apply hydraulic pressure to move the EECs through the system disclosed herein.

Characteristics of the EECs may vary depending on the implementation. If the electrical energy carriers are batteries, the size of the cells may become increasingly smaller as battery cell technology progresses. With smaller electrical energy carriers, the charging and discharging system may be re-sized to suit the size and shape of the EECs. The electrical energy carriers may be rounded, cone shaped, cylindrical, fabiform, toroidal, reniform, ellipsoid, lenticular, or the like. The recharge and charge system may be adapted to the predetermined shape. An element of the shape design requirements is to assist in the orientation and mechanical loading of electrical energy carriers into the recharge and/or discharge system. The EECs have positive and negative terminals for electrically contacting the charging and discharging systems. In some implementations, EECs may be clad in a non-conductive polymer coating with the contacts exposed. A table of possible battery chemistries associated with other physical characteristics is shown in FIG. 12. In preferred embodiments, energy density is maximized, charge rate is rapid, discharge rate is rapid, cost is minimized, and battery chemistry is suitable for construction of a micro- or nano-size cell.

Electrical energy carriers may be stored onboard the EV in a non-conductive fuel container within the transport fluid. When power is required the control system on the EV pumps (via positive air pressure and/or a mechanical pump) EECs in the fluid from the holding container into the discharge system. The EECs are oriented via the transport system for correct electrical polarity via their magnetic properties and/or shape.

The EECs pass through the discharge system and give up their charge while doing so. Upon leaving the discharge system the EECs flow into a non-conductive storage container onboard the EV for discharge later at a filling station.

The EV will require re-filling when there are inadequate charged EECs remaining in the container holding the charged EECs. At the time of refilling the discharged EECs are preferably emptied into the filling station recharge system at the same time the EV takes on charged EECs. Alternately, offloading and onloading may be performed consecutively and/or at different locations.

The filling station may also be a recharge station. The filling station pumps discharged EECs into the recharge system. If the EECs fail an automated test during recharge they are discarded. All charged EECs are stored (in the transport fluid) in non-conductive containers for ready dispensing to EVs.

The system disclosed herein comprises the following components: Electrical energy carriers (e.g. battery cells or capacitors) suspended in non-conductive, lubricating fluid; a discharge system through which the fluid and electrical energy carriers flow; and a recharge system through which discharged electrical energy carriers in the fluid flow.

The system disclosed herein reduces recharge time for EVs. In some implementations, the filling rate may be equivalent to liquid hydrocarbon (gasoline) filling rate since the flowable battery has transport properties similar to fluids. The emptying of discharged flowable battery fluid (with discharged cells or capacitors) can be done simultaneously while refilling of charged flowable battery takes place. In addition, the system reduces EV battery wastage. The cells or capacitors can be checked for yield at the recharging station. Damaged, short-circuited, open circuited or other EECs that won't take a charge can be individually and automatically removed from the fluid for recycling. This reduces total wastage to EEC granularity. Alternate battery technologies, including new battery designs (such as nano-cells) or potentially explosive cells (such as Li-Air cells), can be accommodated by modifying the charging and/or discharging system.

The system disclosed herein allows for solar power to be used for recharging EVs, because the recharging system does not require tens of kiloamps in a short period of time to facilitate a rapid recharge rate. The recharging systems at EV refilling stations can be powered from either the electrical grid or unconventional power sources.

The system disclosed herein enables EV technology for vehicles of many shapes and sizes. Because the flowable battery can fill a container of any shape or size (constraints are self-weight of the fluid and collapse strength of the EECs) this allows EV designers to shape their vehicles without consideration to the size and shape, or standardization of batteries. The tank could easily be as small as 1 liter or larger than 10 kiloliters.

The system disclosed herein includes: an electrical energy carrier, such as a cell or capacitor, that is small, has quick charge and discharge electrical characteristics, is suited to sorting and orientation in an automated matter and is chemically impervious to the fluid that the EEC is suspended in; a container for storing electrical energy carriers, such as battery cells or capacitors, in a fluid so that they can be transported hyrdraulicly in a manner similar to conventional hydrocarbon fluids. This includes a method for storing those EECs within the fluid without accidental short circuits or discharges. Also disclosed is a method of moving electrical energy carriers, such as battery cells or capacitors of various sizes, from one container to another. The method preferably is a hydraulic method. In addition, a method for charging electrical energy carriers, such as battery cells or capacitors, while the EECs are contained in the fluid and moving through the mechanism by hydraulic pressure (i.e. ‘flowing’) is disclosed. The disclosure also describes a method for discharging those EECs into a load while the EECs are contained in the fluid and moving through the mechanism (i.e. ‘flowing’). The EECs may be in aligned in a single layer between and in electrical connection with discharging plates.

The systems disclosed herein are flexible and permit a range of embodiments for the electrical energy carriers suspended in the fluid, system for orientation, or polarization, of the electrical energy carriers, and the charging and discharging systems. In some implementations, the electrical energy carriers may have a nano or micro designs. If the electrical energy carriers are cells, the EECs may have different chemistries. The system may use pump systems to propel the fluid and electrical energy carriers, such as air pressure based, rotary vane based, and/or hopper/chute based pump system designs. Some implementations may use different discharge systems, such as contact plates or other contact based systems, such as brushes and/or commutators, a v-shaped groove or spring-loaded contacts. Some implementations may use different charging and re-charging systems, such as contact plates or other contact based systems, such as brushes and/or commutators, a v-shaped groove or spring-loaded contacts.

The charging and discharging systems described above have been described based on a configuration in which the electric vehicle is configured similarly to a passenger car. However the EV may be any type of vehicle. In addition to passenger cars, other types of vehicle such as a bus used in public transportation, van, truck, railcar, boat, airplane, motorcycle, scooter, or the like can be used with the system disclosed herein. In alternate implementations, the discharge system may be used on any mobile apparatus.

The foregoing has described the principles, preferred embodiments and modes of operation of the present invention however, the invention should not be construed as limited to the particular embodiments and implementations discussed. It will be appreciated that the implementations that have been described in particular detail are merely examples of possible implementations, and that there are many other combinations, additions, or alternatives that may be included. Instead, the above-described implementations should be regarded as illustrative rather than restrictive, and it should be appreciated that variations may be made in those implementations by those skilled in the art without departing from the scope of the present invention as defined by the following claims.

I claim:

1. A system, comprising:
a plurality of electrical energy carriers each having a positive electrode, a negative electrode, a housing sealed to liquid, and at least one orientation feature, wherein the orientation features of the electrical energy carriers are configured to assist alignment of the electrical energy carriers into a single layer with matching orientation of each positive electrode,
a first container for holding the electrical energy carriers in non-conductive fluid, wherein the non-conductive fluid assists in maintaining electrical isolation between the electrical energy carriers,
a second container for holding discharged electrical energy carriers in non-conductive fluid, and
at least one channel having discharge plates disposed on opposite sides of the channel so as to allow the single layer to pass from the first container, between the discharge plates and into the second container impelled by pressure.

2. The system of claim 1, further comprising:
a means for using the orientation features of the electrical energy carriers to align the discharged electrical energy carriers into a discharged layer with matching orientation, and
at least one charging channel having charging plates disposed on opposite sides of the charging channel so as to allow the discharged layer to pass between the charging plates and into the first container impelled by pressure.

3. The system of claim 1, further including a plurality of channels, each having discharge plates, and wherein the orientation features of the electrical energy carriers are used to align the electrical energy carriers into a plurality of single layers with matching orientation of each positive electrode wherein each single layer passes from the first container, between the discharge plates in the corresponding channel and into the second container impelled by pressure.

4. The system of claim 1, wherein the at least one orientation feature comprises a shape of each electrical energy carrier.

5. The system of claim 4, wherein the shape of each electrical energy carrier is ellipsoid and includes an indentation, wherein one of the positive electrode or the negative electrode is located in the indentation.

6. The system of claim 4, wherein the shape of each electrical energy carrier is an asymmetrical shape.

7. The system of claim 1, wherein the at least one orientation feature comprises at least one electrode comprising ferromagnetic material.

8. The system of claim 1, wherein the electrical energy carriers are capacitors.

9. The system of claim 1, wherein the electrical energy carriers are battery cells.

10. The system of claim 1, wherein the electrical energy carriers have rounded edges and are less than ten centimeters in diameter.

11. The system of claim 1, wherein the non-conductive fluid has a low coefficient of friction.

12. The system of claim 1, further comprising a pumping mechanism for providing the pressure, wherein the pressure is at least one of pneumatic pressure or hydraulic pressure, and the pressure impels the electrical energy carriers through the channel having discharge plates and non-conductive pipes disposed between the channel and the first and second containers.

13. The system of claim 1, wherein the system is on an electric vehicle and the discharge plates are electrically connected to an electrical drive system of the electrical vehicle.

14. The system of claim 1, further comprising a means for off-loading discharged electrical energy carriers in the non-conductive fluid from the second non-conductive container.

15. The system of claim 1, wherein one of the discharge plates is provided with springs and configured to ensure electrical contact between each positive electrode in the single layer and the opposite discharge plate is provided with springs and configured to ensure electrical contact between each negative electrode of each electrical energy carrier in the single layer as said electrical energy carrier passes between the discharge plates.

16. A system for charging electrical energy carriers, comprising:
a non-conductive fluid having a low coefficient of friction and maintaining electrical isolation between the electrical energy carriers suspended therein, wherein each of the electrical energy carriers is less than ten centimeters in diameter, shaped without sharp edges, and has a positive electrode, a negative electrode, a sealed housing, and at least one orientation feature, wherein the orientation features of the electrical energy carriers are configured to assist alignment of the electrical energy carriers into a single layer with matching orientation in the non-conductive fluid,
a pumping mechanism for loading non-conductive fluid containing discharged electrical energy carriers into a first non-conductive container via non-conductive pipes,
a second non-conductive container for holding charged electrical energy carriers in non-conductive fluid,
at least one channel having a pair of charging plates disposed so as to allow the single layer to pass through the charging plates and into the second non-conductive container impelled by hydraulic pressure mediated by the non-conductive fluid, and
a means for off-loading charged electrical energy carriers in the non-conductive fluid from the second non-conductive container.

17. A pourable system for energy storage and transfer, comprising:
a non-conductive fluid having a low coefficient of friction,
a plurality rechargeable electrical energy carriers suspended in the non-conductive fluid, wherein each of the rechargeable electrical energy carriers is shaped without sharp edges and has a diameter of less than ten centimeters and an external surface including at least one orientation feature and comprising a positive electrode, a negative electrode, a sealed housing disposed between the positive electrode and negative electrode, and
a means for transferring, via pressure, the non-conductive fluid and the rechargeable electrical energy carriers suspended therein from a storage container through an electrical energy transfer system.

18. The pourable system of claim 17, wherein the electrical energy transfer system is a discharge system and the storage container and discharge system are part of a mobile apparatus.

19. The pourable system of claim 17, wherein the means for transferring the non-conductive carrier fluid and the rechargeable electrical energy carriers comprises:
non-conductive pipes providing a pathway between the storage container and the electrical energy transfer system;
at least one of a pneumatic pump, fluid pump or gravity-fed configuration of the non-conductive pipes; and
an alignment mechanism that interacts with orientation features of the electrical energy carriers in the non-conductive fluid to align the electrical energy carriers into a single layer with matching orientation in the non-conductive fluid, wherein the single layer passes through the electrical energy transfer system via a channel.

20. The pourable system of claim 19, wherein the electrical energy transfer system comprises:
conductive plates disposed on opposite sides of the channel so as to allow the single layer, impelled by pressure, to pass between the conductive plates and make electrical contact therewith for transferring electrical energy; and
a control system for handling electrical current transferred from or to the electrical energy carriers via the conductive plates.
